(19) United States
(12) Patent Application Publication
(10) Pub. No.: US 2007/0055596 A1
(43) Pub. Date: Mar. 8, 2007

(54) System for preparing financial disclosures by unifying financial close and financial control steps

(75) Inventors: STEVE YANKOVICH, SAN JOSE, CA (US); NATHAN HOOVER, LOS GATOS, CA (US); RAJESH BHATIA, HAYWARD, CA (US); ARTHUR ARDIZZONE, CUPERTINO, CA (US); BRANDON DUNCAN, SAN JOSE, CA (US); HAN YUAN, SUNNYVALE, CA (US)

Correspondence Address: PATENTRY, P.O. BOX 151616, SAN RAFAEL, CA, 94915-1616, US

(73) Assignee: MOVARIS, INC, SAN JOSE, CA (US)

(21) Appl. No.: 11/278,519

(22) Filed: Apr. 3, 2006

Related U.S. Application Data
(60) Provisional application No. 60/596,055, filed on Aug. 26, 2005.

(51) Int. Cl. G06Q 40/00

(52) U.S. Cl. 705/35

(57) ABSTRACT

A financial close system of record integrating: managing a financial period close process, attesting to adequate internal controls applicable to the period, displaying qualitative status of confidence and quantitative measure of progress in a financial control and the electronic archiving of the three as an executable and auditable embodiment of a financial period close binder.

### CROSS-REFERENCE TO RELATED APPLICATIONS

The present application claims the benefit of priority under 35 U.S.C. sctn. 119(e) from U.S. Provisional Patent Application No. 60/596,055 filed on Aug. 26, 2005 first named inventor Steve Yankovich.

### BACKGROUND OF THE INVENTION

Traditionally organizations who prepare financial statements (disclosures ie. Quarterly and Annual Reports consisting of Income Statement, Balance Sheet, Tax Footnote, etc.) for external reporting (to the SEC, public, bankers and financial institutions) by manually gathering financial numbers and embodiment text from various systems and people and using computer desktop applications such as Microsoft Word to create a final deliverable form of the financial report. That Word document both turned into printed material for public distribution and into an SEC required format for delivery to them (today that's Edgarized HTML, but in an embodiment a proposed standard XBRL or another electronic format).

During the period of time that these financial reports are being assembled these organizations have hundreds to thousands of tasks (or process steps) that must be completed in order to ensure the accuracy of the numbers, or descriptive text, within the financial statements. These tasks include all the steps involved in the month end financial close, tasks specific to the reporting period the financial statements are for, tasks involved in the various regulatory or compliance requirements around financial data and reporting (accounting controls). All these tasks are most commonly done by people without the benefit of a system to ensure their completion or accuracy. This means that those deciding that the financial statements are in fact ready for external reporting do so with little to no visibility to the quality of the quantitative data (numbers) or text in those statements.

In financial accounting systems, there exist informal processes that bridge from transaction systems to financial statements that are outside the formal systems of record These procedures, executed throughout the financial organization, are necessary to identify and resolve issues and exceptions. Securities and Exchange Commission (SEC) filings cannot and should not be simply the outputs of enterprise resource planning (ERP) and customer relationship management (CRM) software packages for real companies doing business globally, with many subsidiaries, and lines of business without these judgemental and heretofore manual adjustments. Increased regulatory oversight, scandals, and complex accounting rules are causing a growing number of restatements of earnings and other financial reports and resulting focus on auditable, reproducible, and tracible actions.

It should be apparent that documenting internal controls, evaluating, testing, and remediating internal controls has less value if they are not done in concert with their attestation at a time consistent with a financial reporting period rather than in a vacuum asynchronous from reports that will be relied upon. Similarly, the smooth aggregation, analysis and integration of financial data from transactions systems across a major corporation's subsidiaries, sectors, and consolidation of financial accounts, no matter how smooth is of low value if the financial controls during that period are of questionable validity. Thus it can be appreciated that what is needed is a new system, apparatus, and method for coordinating an integrated management and measurement of both a financial close and the attestation of appropriate internal controls over the data used in the financial close.

### SUMMARY OF THE INVENTION

This invention provides the ability to know the state (or status) of all the various disparate tasks involved in the processes leading up to the completed financial statements as well as provide qualitative indicators with respect to the completeness and exceptions of these tasks including accounting control tasks. The invention provides a view of this quantitative and qualitative data directly on the exact final visual representation used in external reporting. Imagine taking the annual report for a business entity and sliding onto a computer screen. It then becomes a console that whose framework (labels, lines, tables, etc.) stays constant but the financial numbers for each reporting period along with qualitative indicators showing good or bad status are displayed so that not only can each statement be judged ready or not, but each line item within each statement can be scrutinized.

This framework, or template, mirroring the exact visual appearance of financial statements the organization has prepared in the past can be made electronic and thus the basis for this console by several means: 1) One could employ a programmatic method that parses the common form these statements may exist in (Word, HTML, XML, XBRL, etc.) and be automatically converted to an appropriate data format so as to act as the inventions console. The console is assumed to be a Web Browser based implementation and so the data format of the inventions view of the financial statements would be an appropriate Web Browser format such as HTML, XML, PDF, or other such format. 2) One could create, or use, a WYSIWYG (what you see is what you get) Web Browser editor to recreate the visual appearance of the financial statements seen immediately on screen as they are created. 3) One could also directly write in the source language of these Web Browser formats with in a word processor or editor as a manual process. In this case the final result of the newly created financial statements would not be seen until presented to a Web Browser.

The present invention is a computer implemented method of planning, monitoring, attesting, and recording the steps employed to reconcile all contributions to financial statement line items and footnotes with accuracy and financial controls in an electronic system of recordation. The present invention comprises three elements: One a system of creating, scheduling, and managing a close process. Two a system of creating, managing, testing, and attesting to a set of internal controls. Three a financial statement readiness console which displays to financial management, auditors, and corporate officers a qualitative status of the progress, completion, or need for attention on either the close process or the set of internal controls so that when the quantitative values of each line of the financial accounts is ready for signoff, the executive team and subsequent analysts can also observe the quality of the numbers with respect to internal control testing and attestation, and the completion of all the close tasks related to each financial account. When the readiness console displays sufficient confidence and completion in the close tasks, an electronic close binder is assembled as a system of record for dissemination.

In summary, the present invention comprises a method for a financial close system of record comprising: managing a financial period close process, attesting to adequate internal controls applicable to the period, displaying qualitative status of confidence and quantitative measure of progress in a financial control and electronic archiving of the three as an executable and auditable electronic embodiment of a financial period close binder.

### DESCRIPTION OF DRAWINGS

FIG. 1 illustrates processes and data supporting a financial statement readiness console.

FIG. 2 illustrates a method of setting up financial statement.

FIG. 3a illustrates a method of defining financial controls.

FIG. 3b illustrates a method of defining financial close tasks.

FIG. 4 illustrates a flow of data in a financial readiness process.

FIG. 5 illustrates a display of qualitative close and control status in a financial statement readiness console.

FIG. 6 illustrates a display of all the financial statement names and the qualitative indicators of readiness.

FIG. 7 illustrates a method of assembling a close binder.

FIG. 8 illustrates a method of producing financial statements

### DETAILED DESCRIPTION

The present invention is a method of unifying financial reporting, close tasks, and internal controls, the method comprising controlling via a system of automating operations referred to as Sarbannes Oxley or SOX controls, closing through a system of planning and tracking the steps referred to as a financial period close, and displaying the readiness for determining the finality of the financial period close.

The present invention further comprises a system and method for determining readiness, delivery and audit of financial statements. There are three life cycles of this system and a method for using the system in each of the life cycles. Initially, the system is used internally to an enterprise by the financial employees dynamically to close a financial period and prepare the financial statements that accurately reflect the activity during the period and the state of the enterprise at the end of the period. This process is referred to as closing. When the responsible executives believe the financial statements are reliable, they shift the system into the second life cycle which is the formal lock down and delivery of the financial statements to internal and external consumers including regulatory agencies and other interested parties. The third set of users are the analysts and auditors who use the system to explore in detail the underlying controls, logic, assumptions, and judgments that support the financial statements. Each of the methods of use will be discussed in detail.

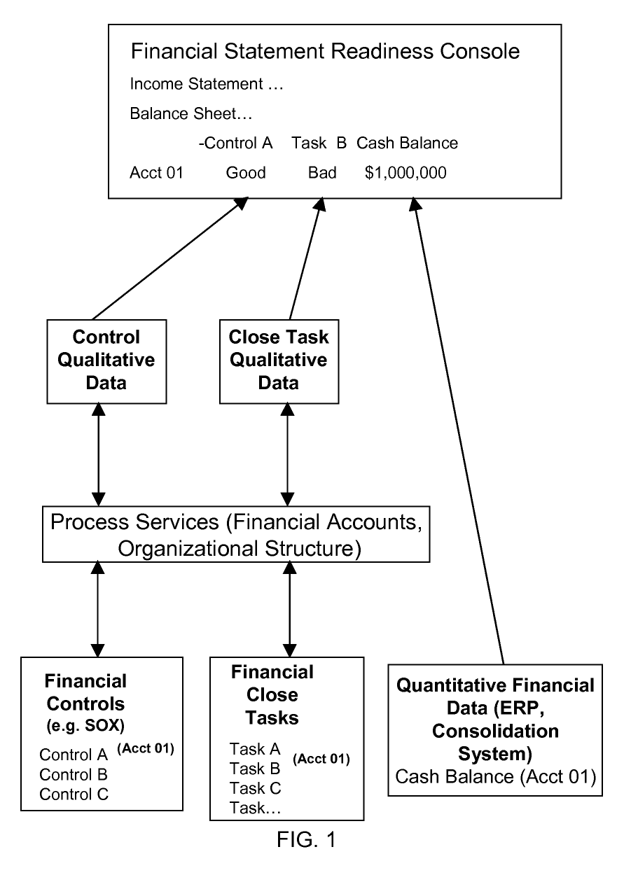

Referring now to the drawings, a system is illustrated in FIG. 1 comprising a processor, input systems, display systems, storage for data and instructions, and computer readable media adapted to control the processor to perform the steps of displaying a financial statement readiness console, displaying for each account quantitative financial data, displaying for each account qualitative data comprising at least one of the following: financial control qualitative data and financial close task qualitative data in the form of icons, colors, words, symbols, text, or graphics, wherein the qualitative data is selectable and invokes display of detailed supporting qualitative data.

The system of FIG. 1 obtains qualitative data from at least one of the following systems: an external system of financial controls and a plurality of financial controls, a plurality of process services that perform the financial controls, collects qualitative metrics about the adequacy of performing the financial controls and maintains a continuous database for each financial account summarizing the qualitative confidence of each account in a financial statement.

The system of FIG. 1 obtains qualitative data from at least one of the following systems: an external system of close tasks and a plurality of financial close tasks, a plurality of process services that perform the close tasks, collects qualitative metrics about the progress of completeness of performing the close tasks and maintains a continuous database for each financial account summarizing the qualitative readiness of each account in a financial statement.

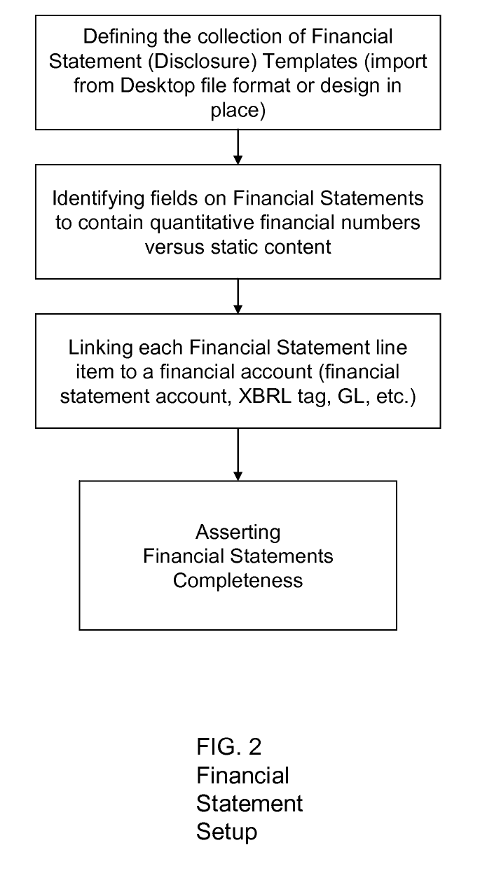

A method for setting up a financial statement is illustrated in FIG. 2 comprising the steps of
defining the collection of a financial statement (disclosure) template using at least one of the following methods importing a template from a desktop file format or designing a template in place,
identifying fields on financial statements to contain quantitative financial numbers and identifying fields on financial statements to contain static content,
linking a financial statement line item to a financial account wherein the financial account is selected from the group comprising financial statement account, XPRL tag, and GL, and
asserting completeness of the financial statement.

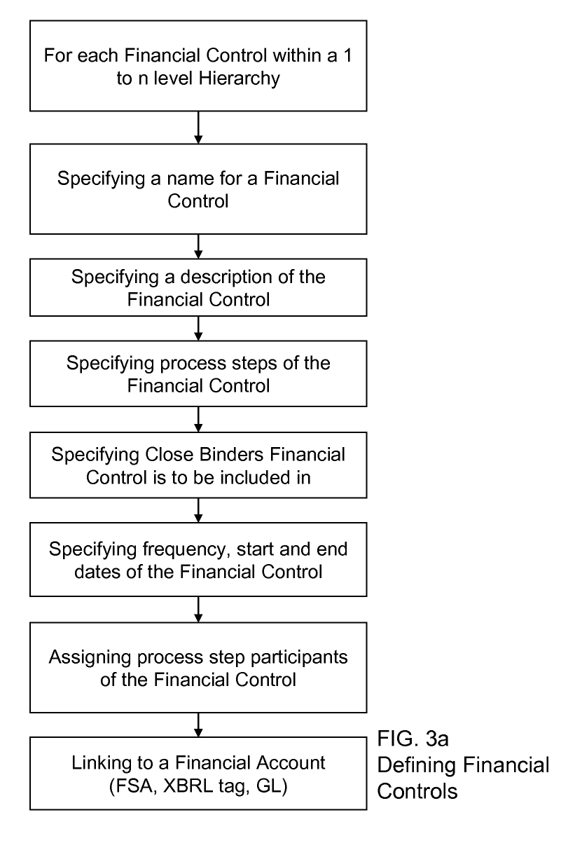

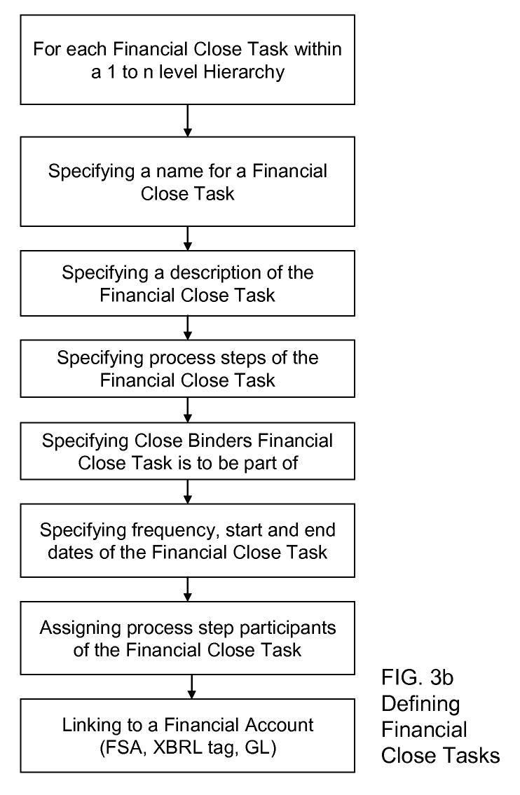

A method of defining financial controls is illustrated in FIG. 3a comprising the steps of
specifying a name for a financial control,
specifying a description of the financial control,
specifying process steps for the financial control, wherein process steps comprise workflow routing between users and business rules used to determine whether a particular routing is needed or business rules used to make a programmatic qualitative judgment of adequacy,
specifying close binders the financial control is to be included in,
specifying frequency, start, and end dates of the financial control,
assigning process step participants of the financial control and
linking the financial control to a financial account wherein the financial account is selected from the group financial statement account, XBRL tag, and general ledger.

A method for defining financial close tasks is illustrated in FIG. 3b comprising the steps of
specifying a name for a financial close task,
specifying a description of the financial close task,
specifying process steps of the financial close task, wherein process steps comprise workflow routing between users and business rules used to determine whether a particular routing is needed or business rules used to make a programmatic qualitative judgment of goodness or badness,
specifying close binders the financial close task is to be part of,
specifying frequency, start and end dates of the financial close task,
assigning process step participants of the financial close task, and
linking the financial close task to a financial account wherein the financial account is selected from the group financial statement account, XBRL tog, and general ledger.

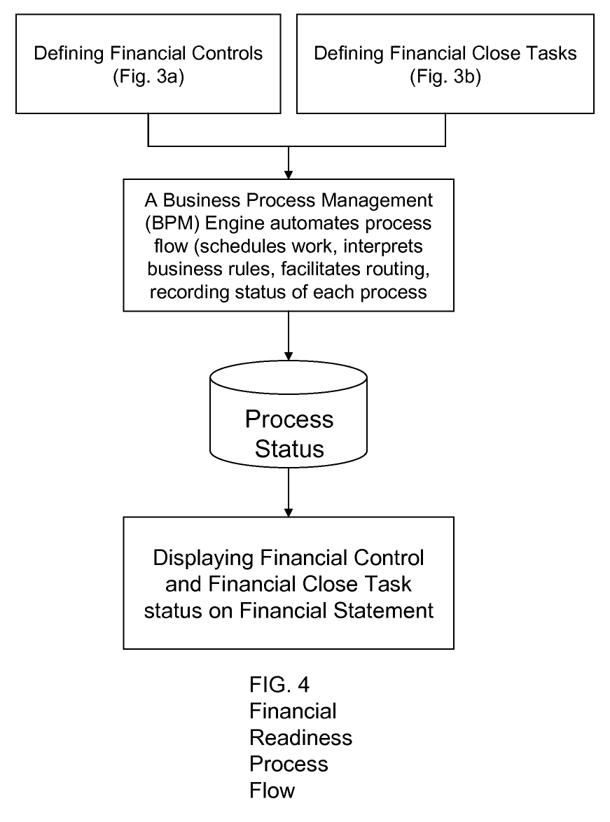

A process for assessing financial readiness is illustrated in FIG. 4 comprising the steps of
defining financial controls,
defining financial close tasks,
scheduling the steps of control and closing,
recording the status of the processes of closing and controlling, and
displaying financial control status and financial close task status on a financial statement.

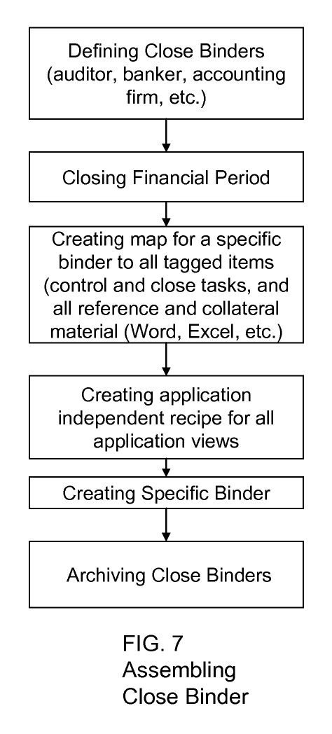

A method for assembling a close binder is illustrated in FIG. 7 comprising the steps of
defining close binders,
closing a financial period,
creating a map for a specific binder to all tagged items including at least one of the following control and close tasks, reference and collateral material files,
creating an application independent recipe for all application views,
creating the close binder, and
archiving the close binder.

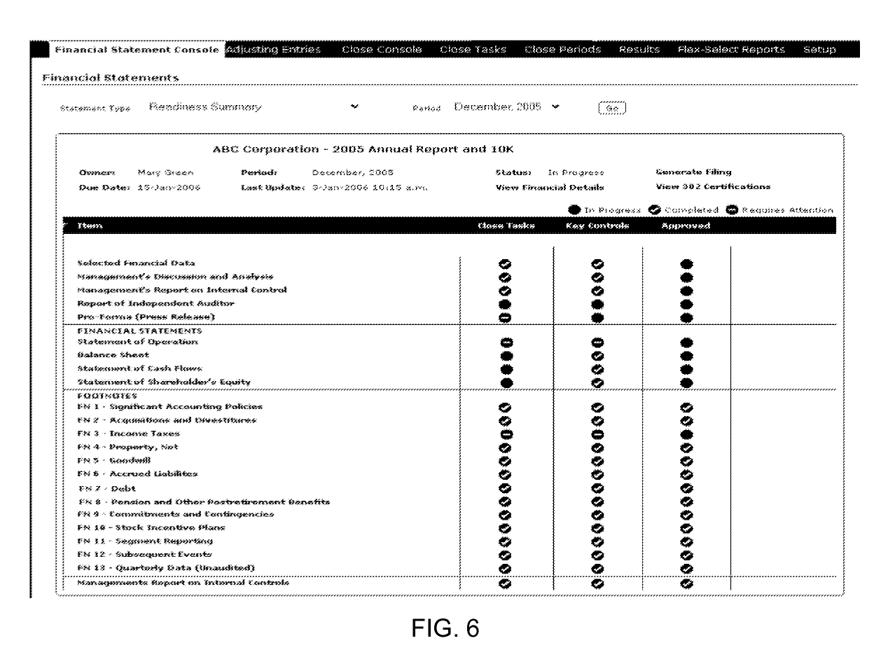

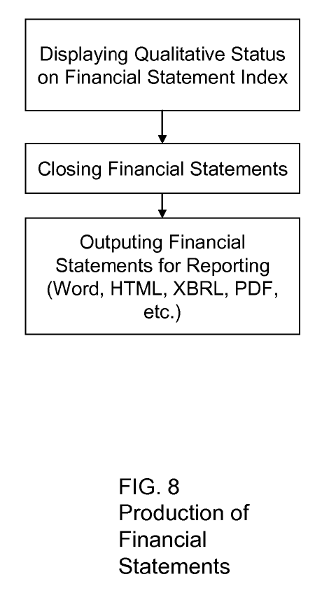

A method for producing financial statements is illustrated in FIG. 8 comprising the steps of
displaying qualitative status on an index of financial statements as illustrated in FIG. 6,
closing financial statements, and
outputting financial statements for reporting in at least one of the following formats: word, html, XBRL, and PDF.

The present invention is disclosed as a specification to those skilled in the art of software development. It can be appreciated that various languages and coding styles can be employed to implement the invention which is described in explicit but neutral terms.

An Embodiment

Close Management is a new application built on top of the Movaris Certainty platform. It can be run standalone or integrated with SOX. It allows the customer to:
Spend more time on risks and issues, less on close mechanics
Reduce the cycle time for the close process
Complete and centralized documentation of entire close process
Standardize close procedures across all entities
Standardize spreadsheets used in the close
Integrate financial close with Sarbanes-Oxley testing and certification
Increased accuracy of the financial statements
Builds close process knowledgebase, reducing likelihood of errors.

Glossary

| Term | Description |
|---|---|
| Application Silo | A Certainty application built on top of the |
| | Certainty Platform. |
| FDF | Adobe's Form Data File format. This format is used to |
| | send form fill-in data from Acrobat to our server or |
| | vice versa. It basically consists of field name-value |
| | pairs. |
| Close Binder | A set of files associated with a monthly Close. In this |
| | application, the files consist of Task and Issue Action |
| | Plans as well as various attachments. |
| Close Entity | A division/unit/group of the company that participates |
| | in the Financial Close. Think of if as a “Close |
| | Business Unit”. |

The present invention comprises converting a Close Task list (typically implemented as a simple Excel spreadsheet) into a hierarchical list of scheduled tasks with assignments. The Close Management Application Silo works either standalone or in tandem with the SOX Application Silo.

The present invention further comprises scheduling, executing and tracking these assignments as follows:
Setting up a Close Calendar, which is based on the Company Calendar, so that the tasks can be scheduled on the right calendar days of each Close period. Close Task due dates can be specified to the minute.
Creating Close Tasks hierarchically. Tagging Tasks as Key (to show up on Console) and mapping Close Tasks to a Close Entity. Tasks can have References linked and Supporting questions.
Linking Close Tasks to SOX Financial Controls, Evaluations, Tests or Summary Tests.
Creating a set of customer-defined Output Packages for each Close Period. The invention further comprises creating an overall Close Binder, said binder including all Action Plans, Attachments and Issues for each Close.
Displaying problem areas of the current close on the Close Console to Close Managers.
Displaying a time-based Close Task List view.
Defining and uploading a list of Approved Spreadsheets.

These are called References in Close Management. This acts as a repository of golden templates from which Close Task Performers fill out the spreadsheets and then attach to their particular Close Tasks, for each Close.

Analysis and Use Cases.

The use of this product is divided into five areas with Use Cases detailed for each:
Setup (Context)
Task Configuration
Close Task Execution
Close Output Packages
Close Transactions.

Close Days

Role: Close Admin

Suggested Close Manager->Setup->Close Days

navigation paths:

Notifications: None

Audit: -

Security: Only Close Admin can perform this task

The present invention comprises enabling the user to define what number of close days for each type of close—Monthly, Quarterly, and Annually.

Later for each close period the administrator would map actual dates to these defined days.

In an embodiment, the only modification of the Close Calendar allowed is:
Changing the names of the Close Days
Adding more Close Days
Remapping Close Days to dates for Close Periods that haven't started yet
Deleting a Close Day.

For the case of deleting a Close Day, there are two possibilities for solving the problem of Task Definitions that have become invalid due to the deletion:
Don't allow deletion of a day that any Task is currently using for a Start or Due Date
Allow deletion but catch the error on Close Start.
   Either choice (or both) can be used when implementing this feature.

Define Output Packages

Role: Close Admin

Suggested Close Manager->Setup->Output Packages

navigation paths:

Notifications: None

Audit: -

Security: Only Close Admin can perform this task

Going to Close Manager->Setup->Output Packages gives a list of currently defined Output Packages. To create a new one, click the New button. On the Output Package definition page, fill in these fields:
Name
Description
Include Issues (check box)
Include Close Documents (check box)
Then click Save.
   Close tasks can then be configured to be included in each defined Output Package.

The default Output Package which is automatically linked to all Close Tasks is called the Close Binder and it is created at install time. It cannot be removed (without Professional Services).

Delete Output Package

Role: Close Admin

Suggested Close Manager->Setup->Output Packages

navigation paths:

Notifications: None

Audit: All changes are tracked in the Audit Trail

Security: Only Close Admin can perform this task

Going to Close Manager->Setup->Output Packages gives a list of the currently defined Output Packages. To delete an Output Package, select the corresponding radio button and click Delete. This Output Package will be deactivated and will not show on the Close Task Definition screen or the Output Packages screen.

Define References

Role: Close Admin

Suggested Close Manager->Setup->References

navigation paths:

Notifications: None

Audit: All changes are tracked in the Audit Trail

Security: Only Close Admin can perform this task

This page allows definition and uploading of the set of reference documents that will be filled out and attached during each close period. ‘References’ is a Platform feature, but the only references visible here are those associated with Close Management. The set of Reference Types will be different than those associated with Sox References. They will be:
Approved template
Close Documentation
Reference Document
Other.
   The set of Reference Types can be edited and added to by a System Administrator.

Optionally include References in Output Packages.

Define Close Entities

Role: Close Admin

Suggested Close Manager->Setup->Close Entities

navigation paths:

Notifications: None

Audit: All changes are tracked in the Audit Trail

Security: Only Close Admin can perform this task

This page allows definition of a list of Close Entities. There is no limit to the number of Close Entities. Close Entities can be renamed and deactivated. The fields required are:
Name (will be used in pull-down)
Description (only used for reporting).
   Close Period Use Cases.

Upcoming Periods

Role: Close Admin

Suggested Close Manager->Close Periods->Upcoming

navigation paths:

Notifications: None

Audit: All changes are tracked in the Audit Trail

Security: Only Close Admin can perform this task

All the MONTHLY periods defined in the company calendar are available for the close. The close administrator can view the ‘not started’ close periods under ‘Upcoming’ periods.

Mapping Close Days and Dates

Role: Close Admin

Suggested Close Manager->Close Periods->Upcoming

navigation paths:

Notifications: None

Audit: All changes are tracked in the Audit Trail

Security: Only Close Admin can perform this task

From the list of upcoming close periods the administrator could click on the name to see the details. The administrator can then select the type of the close (Monthly, Quarterly, Yearly) and then associate specific dates to the close days. Selecting Monthly, Quarterly, Yearly from the drop down will dynamically change the number and names of close days.

Starting a Close Period

Role: Close Admin

Suggested Close Manager->Close Periods->Upcoming

navigation paths:

Notifications: None

Audit: All changes are tracked in the Audit Trail

Security: Only Close Admin can perform this task

Only upcoming periods could be made current or started. From the detail page of a close period the administrator can click ‘Start’ to make the period current. The following checks will be made:
A period is not already started
All tasks that are going to be made part of the period have assignments associated with them
Close period has valid type and close dates associated.
   A warning will be presented to the administrator when he/she tries to start a period while a previous period hasn't been started.

View Changes to Close Period

Role: Close Admin

Suggested Close Manager->Close Periods->Upcoming

navigation paths:

Notifications: None

Audit: All changes are tracked in the Audit Trail

Security: Only Close Admin can perform this task

All changes to the close period definition are auditable and can be viewed by clicking ‘View Audit’ button.

Warning if Close not started on time

Role: All Close Admins

Suggested None

navigation paths:

Notifications: Email notification

Audit: N/A

Security: N/A

If, on the first defined Close Day of a Close Period, that Close hasn't been started yet, an email notification explaining the situation is sent to every defined Close Admin.

Associating Documents

Role: Close Admin

Suggested Close Manager->Close Periods->Upcoming or

navigation paths: Current

Notifications: None

Audit: All changes are tracked in the Audit Trail

Security: Only Close Admin can perform this task

Documents can be added to an upcoming or current period. These documents are displayed as a section in close period details and are created as attachments. These documents appear on the Close Manager Console.

Closing a Period

Role: Close Admin

Suggested Close Manager->Close Periods->Current

navigation paths:

Notifications: None

Audit: All changes are tracked in the Audit Trail

Security: Only Close Admin can perform this task

Only a current period can be closed/completed. This is done by clicking on the ‘Close Period’ button. The administrator will be displayed a snapshot of the close manager console and asked for comments before confirming the close. Completion date attribute for the close period is updated and all output packages are generated.

Update a Close

Role: Close Admin

Suggested Close Manager->Period Close->Update

navigation paths:

Notifications: None

Audit: All changes are tracked in the Audit Trail

Security: N/A

It may be necessary to reopen a Closed Close to update the output packages since any previously open tasks/issues can have had more attachments or transactions made. The UI will be very similar to that for Compete, and when Go is clicked, the output packages are recomputed—these replace the previous output packages for this Close period.

Output Packages

Role: Close Admin

Suggested Close Manager->Close Periods->Completed

navigation paths:

Notifications: None

Audit: All changes are tracked in the Audit Trail

Security: Only Close Admin can perform this task

Output packages are only available for completed/closed periods. Output packages can be download from the detail page of the close period. ‘Close Binder’ will always be available as an output package.

Each Output Package is a Zip file (mime type application/zip) containing:
A single level-deep directory of Issue Action Plan PDF copies that are associated with the Close but not with a particular Close Task, started from the My Certainty page,
A single level-deep directory of Close Documents that were attached to this Close (if selected for the particular Output Package).

A hierarchy of directories that exactly matches the Close Task Hierarchy. Each node that is not a Rollup Task contains:
A copy of the completed Close Task Action Plan PDF,
A copy of each attachment that was made to the Close Task Action Plan,
A copy of each completed Issue Action Plan PDF associated with that Close
   Task (if selected for the particular Output Package).

Task Definitions Use Cases

Create a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation to get to the level where the new Close Task is to be created.

Click the New button.

Fill out required information
Name
Number.

Provide optional information:
Description, Instructions, Scheduling start date, due date, due time, Performer assignment, Approver Assignment (optional), Rollup (check box), Critical (check box), Close Entity (pull-down).

The Close Task Definition can be marked as being contained in any of the defined Output Packages

Can add up to ten Questions (same features as in SOX; used to be called Supporting Data).

Click Save. As with Sox Financial Controls, items that are linked to the definition must be done in an Edit step, not when creating a new definition.

Edit a Close Task Definition

Role: Close Admin

Suggested Close Manager->Close Hierarchy

navigation paths:

Notifications: None

Audit: All changes are tracked in the Audit Trail

Security: Only Close Admin can perform this task

Use the tree navigation or Find field to navigate to the desired Close Task Definition

The following fields can be edited: Name, Number, Description, Instructions, Scheduling frequency, start date, due date, due time, Performer assignment, Approver Assignment (optional), Rollup (check box), Critical (check box), Close Entity (pull-down)

The method comprising linking the Close Task Definition to one or more SOX Financial Controls, Evaluations, Tests or Summary Tests, depending on which was selected as the SOX Control link type at installation time, further comprising linking to any of the four types and have the drilldown on the console go to a new, SOX mixed results page.

The Close Task Definition can be marked as being contained in any of the defined Output Packages, can link references, and can add up to ten Questions.

If Rollup is selected, then there is no actual Close Task Action Plan associated with this Close Task. So the following fields are not required (and should be hidden on the screen):
Scheduling information
All assignments
Supporting Data.

Scheduling frequency can be:
Monthly
Quarterly
Annually
As Needed.

“As needed” Tasks don't have Start or Due dates pre-set. They are started manually from the Task List View with the due date being collected there. Tasks can only be Due on a date in the Close Calendar. Tasks can be started on any date in the Close Calendar, or up to ‘n’ days before the first day. The maximum offset in days before the first Close Day is somewhat arbitrarily set to 15, but is implemented via a hidden System Property so if a different maximum is desired, it can be implemented. The Start and Due pull-downs dynamically show the defined names for the correct Close Days depending on the current value of the frequency.

If a Task is updated while a Close is started but the particular Task hasn't executed yet, then the transaction for that Task is updated appropriately. If the start date was changed such that it should already have been running, it is executed as part of the Save.

Link a SOX FC/Evaluation/Test/Summary Test to a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation or Find field to navigate to the desired Close Task Definition

In the Related SOX Financial Controls section, click the Link button.

A new SOX popup chooser will appear with radio buttons for the object type:
Financial Control
Control Evaluation
Control Test
Summary Test

Pick one and enter a search string and click Find. The matches will be returned—select the one(s) desired and click Choose.

Results for the Linked SOX objects will be shown in the Close Console in the “Key Close Controls—Testing” section. The SOX controls that are reported on in this section are the ones that have already started on any day of the Close Period, regardless of scheduled frequency. This includes manually initiated controls.

Unlink a SOX FC/Evaluation/Test/Summary Test from a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation or Find field to navigate to the desired Close Task Definition. In the Related SOX Financial Controls section, select a linked SOX object and click Unlink.

Delete a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation or Find field to navigate to the desired Close Task Definition. Click Delete. Deleted tasks are not removed from the database, just marked disabled. If any sub-tasks are present, a popup warning is first given, but if Ok is selected, the Task and all Sub-Tasks are marked disabled and are removed from the UI.

If a Close is currently running, there are two cases:
The Task has started already: the matching Close transaction is left unchanged
The Task has not started yet: the matching Close transaction is marked deleted.

Optionally removing these transactions from display instead of marking them deleted.

Copy a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation or Find field to navigate to the desired Close Task Definition. Click the Copy button. A new Close Task definition will be created with the same parent. It will have the text “Copy mm/dd/yyyy hh:mm:ss” appended to the Name and Number fields. Any child tasks (and their children etc) will be copied as well.

View Changes to a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation or Find field to navigate to the desired Close Task Definition. Click the View Audit button.

Move a Close Task Definition

Role: Close Admin

Suggested Close Manager->Close Tasks

navigation paths:

Notifications: None

Audit: All changes are tracked in the Audit Trail

Security: Only Close Admin can perform this task

Use the tree navigation or Find field to navigate to the desired Close Task Definition. Click the Move button. Enter a search string in the Close Task popup finder. The move target (new parent) will be limited to Tasks that are not descendents of the Task being moved.

Add Task to current period

Role: Close Admin

Suggested Close Manager->Close Tasks

navigation paths:

Notifications: None

Audit: Yes

Security: Only Close Admin can perform this task

Once a close period has started (i.e. there is a current close period) any newly created tasks will not be added to current close period. The administrator could add them by manually clicking the button ‘add to current close’. The action will fail under the following conditions:
if the task definition already existed in the close period
if the parent task definition doesn't exist in the close period.

View Results

Role: Close Admin

Suggested Close Manager->Close Tasks

navigation paths:

Notifications: None

Audit: Yes

Security: Only Close Admin can perform this task

From the task definition the administrator should be able to view the results of the various executions of that task by clicking the ‘results’ button.

Tree View

Role: Close Admin

Suggested Close Manager->Close Tasks

navigation paths:

Notifications: None

Audit: NA

Security: Only Close Admin can perform this task

The task definitions are also presented in the tree view format. The administrator should be able to view the task hierarchy. Clicking on the task hierarchy node will also present the task definition screen.

Close Task Execution Use Cases

Here is the flow of the Close Task Action Plan

A close task process comprising the steps of submitting a close task action, selecting a close task performer, performing the close task, approving the close task, and closing the task action.

Manually start a Close Task

A close task can NEVER be manually started from the definition. Only task within a close period can be started either via the scheduler or manually. Only tasks marked ‘As Needed’ can start manually and only as part of a current close period.

Perform a Close Task
Role: Non-privileged User in People table, assigned to this task or Delegated.
Suggested Home->Inbox->select or From Email link
navigation paths:
Notifications: None
Audit: N/A
Security: N/A

Click on Email link or use Inbox or Search feature to bring up PDF for Close Task. Fill out any fields. Optionally attach file(s). Optionally create an Issue (see section 4.3.5). Click Submit. Can Delegate instead of Submit.

Approve a Close Task
Role: Normal User in People table, assigned to Approve this task or Delegated.
Suggested Home->Inbox->select or From Email link
navigation paths:
Notifications: None
Audit: N/A
Security: N/A

Click on Email link or use Inbox or Search feature to bring up PDF for Close Task. Optionally attach file(s). Optionally create an Issue by clicking the “Create Issue” button in the toolbar. <This may have to do an auto-save>. Click Submit. Can Delegate instead of Submit.

Reject a Close Task
Role: Normal User in People table, assigned to Approve this task or Delegated.
Suggested Home->Inbox->select or From Email link
navigation paths:
Notifications: None
Audit: N/A
Security: N/A

Click on Email link or use Inbox or Search feature to bring up PDF for Close Task. Optionally attach file(s). Optionally create an Issue by clicking the “Create Issue” button in the toolbar. <This may have to do an auto-save>Click Reject. Reject can only go back one signature level.

See Overdue Close Tasks
Role: Normal User in People table
Suggested Home
navigation paths:
Notifications: None
Audit: N/A
Security: N/A

The Overdue Control Activities pie chart shows any overdue Close Task Action plans in the user's inbox.

Close Issue Action Plan

There will be a new Close Issue Action Plan created for Close Management. Since the Close Process is much more time sensitive that SOX, the routing is simplified compare to the SOX Issue Action Plan comprising the steps of submitting a close issue action, if the user is not admin, approving the issue, submit an adhoc issue owner, if the user is admin, assigning an issue owner to document plan, documenting a plan to address the issue, approving a plan to address the issue, and closing the issue.

Create an Issue from a Close Action Plan
Role: Normal User in People table, assigned to this task or Delegated.
Suggested Close Action Plan->Create Issue
navigation paths:
Notifications: Issue Action Plan Approver will receive email notification.
Audit: N/A
Security: N/A

Click the new standard toolbar button “Create Issue”.

This will initiate a “behind the scenes” Save of the current Close Task Action Plan. [Maybe with a popup]

The Issue Action Plan will come up with the name of the Close Task mapped.

Fill in the remainder of the Action Plan

Click Submit

The Routing Panel will show a pull-down containing all the currently defined Close Administrators.

Optionally add attachments/comments.

Click Send.

Create an Issue from My Certainty
Role: Normal User in People table
Suggested My Certainty->Close Issue Action Plan->Go
navigation paths:
Notifications: Issue Action Plan Approver will receive email notification.
Audit: N/A
Security: N/A
   Start the Close Issue Action Plan from the start menu.
   The Close Issue Action Plan will not come up with the name of a Close Task mapped. The issue will be linked to the current open Close.
   Fill in the remainder of the Action Plan
   Click Submit
   If there is not current open Close, the Issue cannot be started—a popup error message will inform the user he cannot submit or save his Issue.
   Assuming it is legal to start the Issue, the Routing Panel will show a pull-down containing all the currently defined Close Administrators. The Issue cannot be routed to anyone else.
   Optionally add attachments/comments.
   Click Send.
      Close Task List Use Cases

View a Close Task List—Transactional

Role: Close Admin

Suggested Close Manager->Close Manager Console->Close

navigation paths: Tasklist

Notifications: None

Audit: None

Security: Only Close Admin can perform this task

By default this screen shows the Task Status of all Tasks for the current close, ordered by Close Due date.
The tree navigation also allows choosing previously completed Close periods to see the historical Task Status.

The tree navigation contains ALL tasks including Rollup and “As Needed”. But the Close Task list doesn't contain Rollup Tasks (since there is no associated Action Plan). “As Needed” Tasks are shown in a separate section at the bottom of the Task List. Each task listed in the “As Needed” section has a check-box, and there is a “Start Now” button that, when clicked, prompts for a due date and time, then the selected Task(s) is/are started. Once one of these Tasks is started, it displays in the normal part of the Task List.

The possible states (Status) of each Task in the Task List are selected from the group comprising:
Not Started
In Progress
Completed
Deleted
Cancelled
As Needed.

The Task names in the Task List are links to the Action Plan, but links to the Task Definition in the case of “As Needed” or “Not Started” Tasks.

Tasks that have been linked to at least one SOX Control are flagged with an asterisk.

Export a Close Task List—Transactional

Role: Close Admin

Suggested Close Manager->Close Manager Console->Close

navigation paths: Tasklist

Notifications: None

Audit: None

Security: Only Close Admin can perform this task

The “Export to Excel” button on the Tasklist View screen returns an excel file containing the information currently viewed on the Tasklist screen.

Add Comments to Tasks for a Close

Role: Close Admin

Suggested Close Manager->Close Manager Console->Close

navigation paths: Tasklist

Notifications: None

Audit: None

Security: Only Close Admin can perform this task

For each task the administrator could add a comment by selecting the task and then clicking on the ‘Comments’ button.

Customize Tasklist View

Role: Close Admin

Suggested Close Manager->Close Manager Console->Close

navigation paths: Tasklist

Notifications: None

Audit: None

Security: Only Close Admin can perform this task

The administrator can customize the task list view by clicking the ‘customize view’ link to the top right. This will give the user filter options for the tasklist view.

Close Manager Console

Role: Close Admin

Suggested Close Manager->Close Manager Console

navigation paths:

Notifications: None

Audit: None

Security: Only Close Admin can perform this task

The close manager console display comprising the following elements:
Document associated with close. If more than 5 then more link should appear
List of critical tasks. If more than 5 then more link should appear.
Status of the close tasks in a pie chart.
Status of the close issues in a bar graph and then a pie chart of issue priorities
Status of SOX controls in a pie chart and then a bar graph of non compliance SOX controls.

View a Filtered Close Task List—Transactional

Role: Close Admin

Suggested Close Manager->Close Console->Click on Task Pie

navigation paths: chart

Notifications: None

Audit: None

Security: Only Close Admin can perform this task

Drilling down from a Pie chart brings up a filtered view of Tasks with status.

View a Filtered Issue Results List

Role: Close Admin

Suggested Close Manager->Close Console->Click on Issues

navigation paths: Pie chart

Notifications: None

Audit: None

Security: Only Close Admin can perform this task

Drilling down from a Pie chart brings up a filtered Results list of Issues.

Close Transaction and Output Package Use Cases

Retrieve an Output Package

Role: Close Admin

Suggested Close Manager->Binder Output

navigation paths:

Notifications: None

Audit: None

Security: Only Close Admin can perform this task

This screen starts with a pull-down of the Closes that have been Completed. Select one and click Go.
Now the screen shows a list of the defined Output Packages (always including the overall package called ‘Close Binder’).
Pick an Output Package and Click Go.
If the package has been retrieved previously, it is simply pulled from storage and served up. If not, it is generated, stored in storage, then served.
   User Interface

Information Architecture Changes

If the Close Management feature is installed (enabled in the license file), Close Administrators see a new top level tab “Close Management” in the UI. This tab has the following sub-tabs:
Close Manager Console
Close Tasks
Close Periods
Results
Setup.

Data Objects/Java Classes.

Each of the following 17 Objects will be implemented using the Connector pattern for data access.

Full cache: com.movaris.close.core.connector.closeperiod.ClosePeriod.java
Full cache: com.movaris.close.core.connector.closeday.CloseDay.java
Full cache: com.movaris.close.core.connector.closedaymap.CloseDayMap.java
Full cache: com.movaris.close.core.connector.closeoutputpackagedefinition.CloseOutputPackageDefinition.java
Full cache: com.movaris.close.core.connector.closeentity.CloseEntity.java
Partial cache: com.movaris.close.core.connector.closetaskdefinition.CloseTaskDefinition.java
Partial cache: com.movaris.close.core.connector.closetasksoxintersection.CloseTaskSoxIntersection.java
Partial cache: com.movaris.close.core.connector.closetaskoutputpackageintersection.CloseTaskOutputPackageIntersection.java
No cache: com.movaris.close.core.connector.closetasktransaction.CloseTaskTransaction.java
No cache: com.movaris.close.core.connector.closesnapshotoutput.CloseSnapshotOutput.java
No cache: com.movaris.close.core.connector.closesnapshotsox.CloseSnapshotSox.java
No cache: com.movaris.close.core.connector.closesnapshotreference.CloseSnapshotReference.java
No cache: com.movaris.close.core.connector.closeoutputpackage.CloseOutputPackage.java
No cache: com.movaris.close.core.connector.closeoutputpackagedata.CloseOutputPackageData.java
No cache: com.movaris.close.core.connector.closedocument.CloseDocument.java
No cache: com.movaris.close.core.connector.closedocumentdata.CloseDocumentData.java
No cache: com.movaris.close.core.connector.closeiap.Closelap.java
   APIs

New System Values

Close Reference Types

A new LOV family called ‘closereftype’ will be created to contain the different possibilities for Close Reference Types. In LOV_SYS_GROUP:

Name: Close Reference Type

Export: closereftype

Can Deactivate: No

Can Add: Yes

Can Rename: Yes

In LOV_SYS:

Name, Short name, Export, Order

‘Approved template’, ‘A’, ‘A’, 1

‘Close Documentation’, ‘C’, ‘C’, 2

‘Reference Document’, ‘R’, ‘R’, 3

‘Other’, ‘O’, ‘O’, 4

Close Status Types

A new LOV family called ‘closestatustype’ will be created to contain the different possibilities for Close Status Types. In LOV_SYS_GROUP:

Name: Close Status Type

Export: closestatustype

Can Deactivate: No

Can Add: No

Can Rename: No

In LOV_SYS:

Name, Short name, Export, Order

‘Not Started, ‘N’, ‘N’, 1

‘In Progress’, ‘P’, ‘P’, 2

‘Complete, ‘C’, ‘C’, 3

Close Source Types

A new LOV family called ‘closesourcetype’ will be created to contain the different possibilities for Close Source Types. These are needed so that the various Close

Data Objects can be audited. In LOV_SYS_GROUP:

Name: Close Source Type

Export: closesourcetype

Can Deactivate: No

Can Add: No

Can Rename: No

In LOV_SYS: a row for each of the 17 Close tables. The Export column is the exact name of the table, for instance: CL_PERIOD.

Managers

Managers are classes that contain business logic. Four Managers will be introduced to manage Close activities. The four Managers are derived from an empty base class CloseManager which is introduced to make the design more flexible. For example, if we later decide to use a Manager framework, this class can extend or implement the base framework class, so that all the CloseManagers defined here can benefit from the framework.

The CloseManagers are all singletons in this class structure comprising a closesetupmanager, a closesecuritymanager, a closetransactionmanager, and a closeuimanager.

CloseSetupManager

CloseSetupManager handles is used to perform actions on any of the definitional information associated with Close Management:

Close Calendar setup/configuration
Output Package definitions
Close Entity definitions
Close Reference definitions
CloseTransactionManager

CloseTransactionManager is used to perform actions on any of the transactional information associated with Close Management:
Start & Complete Close periods
Create and retrieve Output Packages
Attach and retrieve Close Documents
Create and maintain Close Task Definitions (may move to its own manager if needed).

Generalized TreePathCache

In SOX, there is one data structure that very closely mirrors that for Close Task Definitions and for Close Task Transactions: the Business Unit tree. Since the FCC needs to do Unit aggregation, the UnitIdPathCache class was implemented for release 8.1. This class implements an in-memory, lazily-evaluated caching mechanism that provides two public methods:
getAggregateUnitIdList(parentUnitId)—returns list of Ids of all descendents
invalidateCache(unit)—called when units are moved.

Two generalizations of this mechanism are needed for Close Management and will extend an abstract base class called TreePathCache:
CloseTaskDefinitionTreePathCache( )
CloseTransactionTreePathCache( )
which will have two public methods:
getAggregateChildIdList(key)
invalidateCache(key).

The keys would be Close Task ids for CloseTaskDefinitionTreePathCache( ) and a combination of a Close Period Id and a Close Transaction Id for CloseTransactionTreePathCache( ).

Close Issue Action Plan

There may be a new Close Issue Action Plan—it was decided to implement a separate (new) Action Plan rather than to try and leverage the existing SOX Issue Action Plan, even though that is technically possible. Future maintenance will be much simple with this approach.
The schema that supports this new Issue Action Plan will also be separate from the existing Issue Action Plan transaction table.
The Close Issue Action plan will have a due date that is set by the user who specifies the Issue Owner. There will not be escalation.

There are two modes of use for the Close Issue Action Plan:
Invocation from a Close Task Action Plan
The Close Task Performer or Approver may click the “Create Issue” button on the action plan toolbar. This automatically saves any work done on the Close Task Action Plan, then launches a new Close Issue Action Plan, which comes up linked to the Close Task in the current Close Period.

Invocation from the My Certainty

Anyone may initiate a Close Issue Action Plan from My Certainty, however, this can only be done during the period that there is a Close in progress. The Close Issue Action plan is presented, linked to the current Close Period, but not to any specific Close Task.

Methods

A method is disclosed of using the financial statement console by auditors or analysts to understand the locked reports by examining all data and processes that contributed to completed financial statements comprised of viewing text labels, numerical values, and variable clickable symbols displayed on the visual display of a top level financial statement template and clicking on the variable clickable symbols that denote subjective importance, caution, or key issues thereby navigating to either another financial statement template, or to another navigational aide such as a list of items including as an illustration: financial close task status and information; financial control (including SOX) status and information; enterprise resource planning and financial systems links; analytics, business Intelligence and FP&A system links; or unstructured data.

A method is disclosed of using the financial statement console by responsible executives upon their determination that the statements present fairly the financial position and results of operations of their enterprise to sign, lock down, write protect any all data beneath the top level financial statement template comprising the steps of date/time stamping as part of a particular Financial Statement period; executing a digital signature (PKI or other); executing a database storage access protection process; executing a data archival process into a static protected format (such as locked Acrobat PDF, or locked Msft Office tool file formats) and creating one or more output packages that may be transmitted and externally used.

A method is disclosed for creating a financial statement readiness console comprising the steps of importing a previously used Financial Statements (FS) as a template (these can be hierarchical in nature with one FS at the top with lower level FS's rolling up to the top FS; activating the imported FS's as visual maps into the financial metadata that provide both quantitative and qualitative information about each and every item (row, column and text label) of each financial statement said financial metadata comprising:
financial close task status and information
financial Control (including SOX) status and information
ERP and financial systems links
analytics, business Intelligence and financial planning and analysis system links
and unstructured data;
applying variable symbols onto the Financial Statement templates which can indicate status of completion and quality of the quantitative and qualitative processes and data under each item within the FS;
displaying variable symbols and each FS item (row, column, text label) as a clickable symbol that thru programmatic computer methods navigates to the financial metadata; constructing a list of accounts (financial statement accounts, (FSA)) to be used to map each line item of the FS template to the financial metadata including a one to many mapping; constructing a list of FS output packages (name the package, determine its recipient(s), delivery schedule, FS periods to include and output file types (such as Physical CD, HTML, ASCII, Acrobat PDF, XBRL) and
assigning the financial metadata to a financial statement account to complete the linkage of the template to the data and processes.

A method for creating a dynamic financial statement readiness console is disclosed comprising the steps of connecting key financial close processes to a display of financial statement line items, connecting Sarbannes-Oxley financial control certification monitoring to financial statements, connecting annotated supporting documents to financial statement fields, connecting close process task tracking to financial statement line items, connecting subjectively graded risk assessments to financial statement line items, displaying the status or progress of close tasks graphically on financial statement, displaying the aggregate level of confidence or assessment of quality on financial statement, extracting the essential line items from a previous report submitted to regulatory agencies, associating one or more financial accounts to each essential line item, linking the financial statement account to close tasks assigned to closing the account, linking internal controls to close tasks, linking financial statement accounts to close issues, displaying an aggregate report and graphic illustrating the severity of close issues, the percent and number of close tasks completed, the percent and number of key close controls within compliance, the target dates, and the dates of completion; displaying a hierarchy of categories of tasks, controls, and supporting documents; displaying the detailed description of close tasks scheduled by day of the close period, responsibility, status, and approval; displaying qualitative information about the readiness of a financial statement; displaying a income statement with clickable symbols to pop detailed information for each line item; displaying an audit trail of how line item data was extracted from an ERP system; displaying a status of the testing of controls for each item of a financial statement; displaying the date of the close period on the financial statement; and initiating archival, syndication, conversion, translation, and submission when digitally approved.

Additional Methods:

A computer implemented method of preparing and issuing a financial report to regulatory agencies comprising the steps of selecting a graphical icon on an image of a pro form a financial display; displaying a list of one or more tasks contributing to the closing of each financial account; displaying a graphical element illustrating the subjective confidence in the quality of each financial account; selecting a numerical element on an image of a pro form a financial display; displaying the source document supporting a numerical element; displaying the calculation supporting a numerical element; displaying the assigned responsibilities for performing each task; and digitally signing the financial report to archive the data, extract a file for submission according to the specification of the regulatory agency, and publish the report to authorized readers.

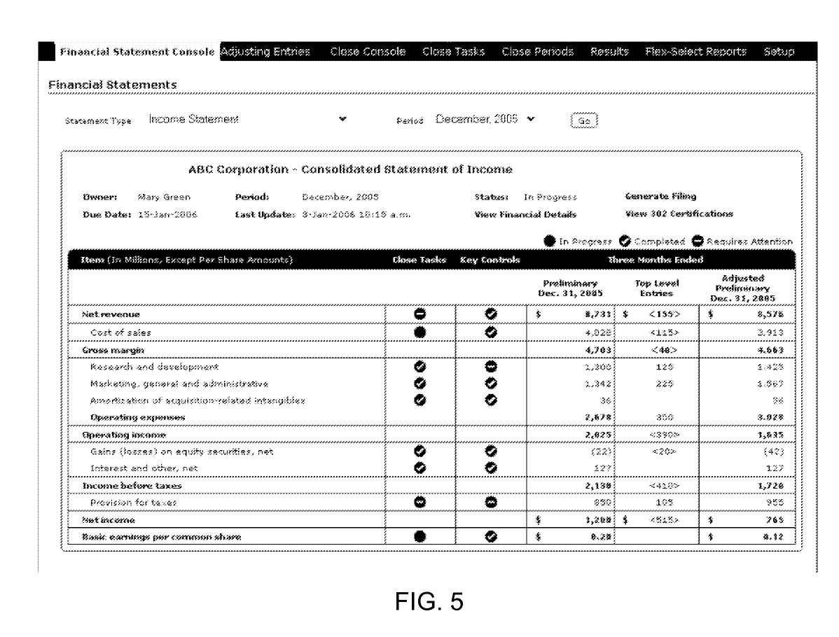

A computer-implemented method of displaying the intermediate results and progress of performing a financial close of an accounting period illustrated in FIG. 5 comprising the steps of accessing a computer readable file representing a financial report submitted to a regulatory agency; copying all the graphic, images, and field names previously used into a new document; inserting a graphical image for each field linked to a description of one or more close tasks contributing to the financial close of the field; inserting a graphical image tag for each field linked to a color table which illustrates the subjective confidence or quality of values provided for each field; linking each field to a display of the calculation or source of the values in each field; and inserting an approval field for an authorized user to digitally sign and certify the correctness of the financial report.

A method, tangibly implemented in a computer system, for closing a financial accounting period, comprising the steps of establishing a work calendar, nomenclature, and number of work days in a window relative to the close date of a financial period appropriate to the business and financial policies of the enterprise; defining the electronic contents of a close binder which would be the work product and record of all tasks, activities, and decisions deemed necessary to record, document, and illustrate the best practices associated with performing a financial close appropriate to the business and financial policies of the enterprise; identifying organizations, departments, or functions that would be responsible for executing, completing, verifying, or escalating issues necessary for the timely completion of the electronic contents of a close binder for any period; assigning individuals and recording their contact information for each of the roles defined necessary to perform, audit, or escalate the issues surrounding the creation of a close binder; synchronizing the close date to a plurality of calendar dates according to the computer system wherein the begin and due date of tasks relative to a close date can be computed to determine the begin and due dates of activities by the calendar; coordinating the activities of the individuals assigned to perform the tasks associated with creating a close binder, further comprising notifying, monitoring, tracking, and escalating the individual and his progress or timely completion of tasks; recording the results of the close task activities, further comprising the attachment of supporting electronic documents, the notes made supporting decisions, the data from external sources entered into the system, the reconciliations of various inputs, and official signatures of attestation; upon attestation that all tasks have been completed, all exceptions have been annotated, all issues have been addressed, and all results are correct, formally closing the financial period and locking down the close binder from further modification; and distributing the selected contents of the close binder to authorized consumers of the information such as the securities and exchange commission, financial accounting services, and the board of directors.

The method tangibly implemented on a computer system for reopening and reclosing the books comprising the steps of placing a close binder under source code control, proposing changes, documenting changes, explaining changes, approving or rejecting changes, locking down with recorded authorship and approval of changes and redistributing the close binder with changed results marked as corrections.

The method tangibly implemented on a computer system of scheduling and monitoring tasks of a financial close comprising the following steps of comparing the plurality of close dates of financial periods to the system clock to obtain the offset; comparing the list of completed tasks to the list of tasks that should be activated according to the offset date from any close date; notifying the individuals, organizations, departments, or function of their desired activity relative to tasks scheduled for the timely completion of a financial close; displaying the status of activities in the list of all activities necessary for the timely completion of the financial close to the plurality of managers responsible for its success; and escalating the absence of completion or activity as a new issue to the attention of managers responsible for the completion of the financial close.

The method tangibly implemented in a computer system of archiving and syndicating all of the electronic files associated with a financial close including electronically signed documents of attestation, best practices and directed procedures, reports from external entities or enterprise resource planning systems, records of changes and modifications, memorandum of decisions, results of computations and the formulas supporting them, audits of physical or financial assets, and an electronic signature ensuring integrity of the archive or syndication.

The method tangibly implemented in a computer system of linking tasks defined in a financial close system to elements of a Sarbannes-Oxley system of financial controls so that notes related to compliance or non-compliance to financial controls can automatically transfer to the financial close system thereby documenting non-compliance yet still enabling the forcing of a financial period close.

The method tangibly implemented in a computer system of assigning tasks relative to a close date, computing the offset to the close date compared to the system calendar, electronically notifying individuals of the begin and end date of their tasks, recording activity, inactivity, or completion of tasks for display to managers responsible for timely completion of the close, archiving and producing an output package that is self contained in documenting the procedures, calculations, initiating and resolving of issues, assignment of responsibility, assumptions, exceptions, notes, reports, adjustments, and attestation of the results for syndication.

A method comprising linking a computer implemented display of an element of a financial statement to firstly one or more computer monitored financial period close processes and linking the display of said element secondly to one or more computer monitored financial controls wherein the element of a financial statement may be a footnote or paragraph or financial statement line item, whereby a control panel may display a visual representation of the progress and quality of each element of a financial statement said representation being a computer selectable element of a control panel.

A method comprising aggregating the status of a plurality of financial controls to cause a summary display and a selectable detailed display of all financial controls that pertain to an element of a financial statement displayed in a control panel, and further comprising aggregating the progress of a plurality of financial period close processes to cause a summary display and a selectable detailed display of all financial period close processes that pertain to an element of a financial statement displayed in a control panel.

A method for building an electronic close binder comprising
recording on a computer readable media of certain representations of the completion of steps pertaining to a financial period close process,
recording on said computer readable media of certain representations of the attestation of performance of financial controls pertaining to an element of a financial statement,
determining the quantitative and textual content of each element of a financial statement,
recording supporting records of values within financial statement accounts, and
recording the formal certification and attestation that the values are accurate as of the date of recordation by authorized officers, whereby navigating a computer display of the financial statement elements through a control panel allows a reader to examine the supporting values, and record of completion of close process steps and of financial controls.

A system for preparing integrated reports of regulated corporate entities, tangibly implemented in a network attaching computers, displays, and storage devices in which are readably encoded processor instructions, comprising the following methods: displaying a financial statement readiness console, closing a financial accounting period, and complying to standards mandating attestation to proper internal management controls.

A system for preparing integrated reports of regulated corporate entities, tangibly implemented in a network attaching computers, displays, and storage devices in which are readably encoded processor instructions, comprising the following methods:
displaying a financial statement readiness console
   wherein displaying comprises the steps of
      displaying a financial statement account line item aggregated within one of the following groups: balance sheet, income statement, dot dot
      displaying a plurality of columns of quantitative values for the line item,
      displaying one or more columns of qualitative assessment of the confidence in the quantitative values
         wherein the qualitative assessment is selected from among the following group:
no open issues and all tasks complete;
no open issues and no late tasks;
at least one open late task or at least one open issue;
no tasks were related to the financial statement account,
no open issues, no open remediations/exceptions, no open controls;
no open issues, no remediations/exceptions, no late controls;
at least one open remediation/exception, at least one open issue or at least one late control;
no close tasks or financial controls were related to the financial statement account;
closing a financial accounting period
wherein closing comprises the steps of
defining a close binder of reports supporting financial account items,
itemizing the close tasks which must be accomplished to close a period,
creating a close calendar of days relative to the beginning or end of a period,
assigning close tasks to members of the financial staff,
scheduling close tasks according to a day in the close calendar,
measuring progress of attainment of close tasks on schedule, and
qualitatively assessing the confidence in attaining a timely close as selected from among the following group:
no open issues and all tasks complete;
no open issues and no late tasks;
at least one open late task or at least one open issue; and
complying to standards mandating attestation to proper internal management controls
wherein complying comprises the steps of
defining a dual hierarchy of financial controls and financial groups,
defining a financial objective for control,
defining a financial control task comprising the steps of
describing a procedure, testing the effectiveness of the procedure, and attesting to the performance and testing of the procedure,
assigning the performance and attestation of each task to a financial group,
scheduling the performance of a financial control task,
measuring the progress against the schedule of all tasks, and
qualitatively assessing the quality of the financial control in aggregate as selected from among the following group:
no open issues, no open remediations/exceptions, no open controls;
no open issues, no remediations/exceptions, no late controls;
at least one open remediation/exception, at least one open issue or at least one late control.

The method further comprises displaying qualitative assessment of internal controls wherein a clickable icon, graphic, or text button is displayed which upon being activated then displaying one or more statistics supporting the qualitative assessment selected from the group following:
Closed Control Tests: ##
Closed Remediations: ##
Closed Exceptions: ##
Closed Issues: ##
Open Control Tests: ##
Closed Remediations: ##
Closed Exceptions: ##
Closed Issues: ##
Late Control Tests: ##/##
Open Remediations: ##/##
Open Exceptions: ##/##
Open Issues: ##/##.

The method further comprises displaying qualitative assessment of financial close process wherein a clickable icon, graphic, or text button is displayed which upon being activated then displaying one or more statistics supporting the qualitative assessment selected from the group following:
Tasks Completed: ##
Closed Issues: ##
Tasks In Progress: ##
Tasks Not Started: ##
Closed Issues: ##
Tasks Late: ##/##
Open Issues: ##/##.

The method of defining a dual hierarchy of controls and actors further comprising; listing high level control objectives attached to a plurality of control tasks that support the attainment of the control objectives which may be less abstract and more procedural in descending the hierarchy; and listing high level officers or executives who are responsible for attesting to the existence and use of high level controls attached to a plurality of potential actors within a financial management organization who may be supervisory, advisory, or operational in role in descending the hierarchy and wherein the upper level of actors attain their upper level controls by assigning and tracking their lower level actors to more detailed lower level controls in the control hierarchy.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

### CONCLUSION

Traditionally organizations who prepare financial statements (e.g. Quarterly and Annual Reports consisting of Income Statement, Balance Sheet, Tax Footnote, etc.) for external reporting (to the SEC, public, bankers and financial institutions) by manually gathering financial numbers and embodiment text from various systems and people and using computer desktop applications such as Microsoft Word to create a final deliverable form of the financial report. That Word document both turned into printed material for public distribution and into an SEC required format for delivery to them (today that's Edgarized HTML, but maybe XBRL or another electronic format).

During the period of time that these financial reports are being assembled these organizations have hundreds to thousands of tasks (or process steps) that must be completed in order to ensure the accuracy of the numbers, or descriptive text, within the financial statements. These tasks include all the steps involved in the month end financial close, tasks specific to the reporting period the financial statements are for, tasks involved in the various regulatory or compliance requirements around financial data and reporting (accounting controls). All these tasks are most commonly done by people without the benefit of a system to ensure their completion or accuracy. This means that those deciding that the financial statements are in fact ready for external reporting do so with little to no visibility to the quality of the quantitative data (numbers) or text in those statements.

This invention provides the ability to know the state (or status) of all the various disparate tasks involved in the processes leading up to the completed financial statements as well as provide qualitative indicators with respect to the completeness and exceptions of these tasks including accounting control tasks. The invention provides a view of this quantitative and qualitative data directly on the exact final visual representation used in external reporting. Imagine taking the annual report for a business entity and sliding onto a computer screen. It then becomes a console that whose framework (labels, lines, tables, etc.) stays constant but the financial numbers for each reporting period along with qualitative indicators showing good or bad status are displayed so that not only can each statement be judged ready or not, but each line item within each statement can be scrutinized.

This framework, or template, mirroring the exact visual appearance of financial statements the organization has prepared in the past can be made electronic and thus the basis for this console by several means: 1) One could employ a programmatic method that parses the common form these statements may exist in (Word, HTML, XML, XBRL, etc.) and be automatically converted to an appropriate data format so as to act as the inventions console. The console is assumed to be a Web Browser based implementation and so the data format of the inventions view of the financial statements would be an appropriate Web Browser format such as HTML, XML, PDF, or other such format. 2) One could create, or use, a WYSIWYG (what you see is what you get) Web Browser editor to recreate the visual appearance of the financial statements seen immediately on screen as they are created. 3) One could also directly write in the source language of these Web Browser formats with in a word processor or editor as a manual process. In this case the final result of the newly created financial statements would not be seen until presented to a Web Browser.

The invention then further provides for a way to link each piece of financial data that will be fed into this console with the tasks (financial close or other) and also the financial controls. This is a link of one to many with one piece of quantitative financial data on the financial statement being linked to potentially man tasks and financial controls. This linking is done by associating a financial account (e.g. Financial Statement Account, General Ledger Code, Account Number, etc.) with the financial statement quantitative data and all the related tasks and financial controls.

This now provides a financial statement readiness console showing a familiar view of financial statements with quantitative and qualitative information flowing into this console for determining when external reporting can be done. The flow of information into this console is covered by other areas of this invention.

What is claimed is:

1. A method comprising linking a computer implemented display of an element of a financial statement to firstly one or more computer monitored financial period close processes and linking the display of said element secondly to one or more computer monitored financial controls wherein the element of a financial statement is at least one of a footnote, paragraph, and financial statement line item, whereby a control panel displays at least one of a visual representation of the progress and a visual representation of the quality of each element of a financial statement said representation being a computer selectable element of a control panel.

2. The method of claim 1 further comprising at least one of aggregating the status of a plurality of financial controls to cause a summary display and a selectable detailed display of all financial controls that pertain to an element of a financial statement displayed in a control panel, and aggregating the progress of a plurality of financial period close processes to cause a summary display and a selectable detailed display of all financial period close processes that pertain to an element of a financial statement displayed in a control panel.

3. A system for preparing integrated reports of regulated corporate entities, tangibly implemented in a network attaching computers, displays, and storage devices in which are readably encoded processor instructions, adapted to perform the following methods: displaying a financial statement readiness console, closing a financial accounting period, and complying to standards mandating attestation to proper internal management controls.

4. The system of claim 3 further comprising the following methods:
displaying a financial statement readiness console
wherein displaying comprises the steps of
displaying a financial statement account line item,
displaying a plurality of columns of quantitative values for the line item,
displaying at least one column of qualitative assessment of the confidence in the quantitative values
wherein the qualitative assessment is selected from among the following group:
no open issues and all tasks complete;
no open issues and no late tasks;
at least one open late task or at least one open issue;
no tasks were related to the financial statement account;
no open issues, no open remediations/exceptions, no open controls;
no open issues, no remediations/exceptions, no late controls;
at least one open remediation/exception, at least one open issue or at least one late control;
no close tasks or financial controls were related to the financial statement account;
closing a financial accounting period
wherein closing comprises the steps of
defining a close binder of reports supporting financial account items,
itemizing the close tasks which must be accomplished to close a period,
creating a close calendar of days relative to the beginning or end of a period,
assigning close tasks to members of the financial staff,
scheduling close tasks according to a day in the close calendar,
measuring progress of attainment of close tasks on schedule, and
qualitatively assessing the confidence in attaining a timely close as selected from among the following group:
No open issues and all tasks complete;
no open issues and no late tasks;
at least one open late task or at least one open issue; and
complying to standards mandating attestation to proper internal management controls
wherein complying comprises the steps of
defining a dual hierarchy of financial controls and financial groups,
defining a financial objective for control,
defining a financial control task comprising the steps of
describing a procedure, testing the effectiveness of the procedure, and attesting to the performance and testing of the procedure,
assigning the performance and attestation of each task to a financial group,
scheduling the performance of a financial control task,
measuring the progress against the schedule of all tasks, and
qualitatively assessing the quality of the financial control in aggregate as selected from among the following group:
no open issues, no open remediations/exceptions, no open controls;
no open issues, no remediations/exceptions, no late controls;
at least one open remediation/exception, at least one open issue or at least one late control.

5. The method of claim 4 for displaying qualitative assessment of internal controls wherein a clickable icon, graphic, or text button is displayed which upon being activated then displaying one or more statistics supporting the qualitative assessment selected from the group following:
Closed Control Tests: ##
Closed Remediations: ##
Closed Exceptions: ##
Closed Issues: ##
Open Control Tests: ##
Closed Remediations: ##
Closed Exceptions: ##
Closed Issues: ##
Late Control Tests: ##/##
Open Remediations: ##/##
Open Exceptions: ##/##
Open Issues: ##/##.

6. The method of claim 4 for displaying qualitative assessment of financial close process wherein a clickable icon, graphic, or text button is displayed which upon being activated then displaying one or more statistics supporting the qualitative assessment selected from the group following:
Tasks Completed: ##
Closed Issues: ##
Tasks In Progress: ##
Tasks Not Started: ##
Closed Issues: ##
Tasks Late: ##/##
Open Issues: ##/##.

7. The method of defining a dual hierarchy of controls and actors of claim 4 comprising; listing high level control objectives attached to a plurality of control tasks that support the attainment of the control objectives which may be less abstract and more procedural in descending the hierarchy and;
listing high level officers or executives who are responsible for attesting to the existence and use of high level controls attached to a plurality of potential actors within a financial management organization who may be supervisory, advisory, or operational in role in descending the hierarchy and wherein the upper level of actors attain their upper level controls by assigning and tracking their lower level actors to more detailed lower level controls in the control hierarchy.

8. A program product embodied in computer-readable medium adapted to cause a processor to perform the method of preparing and issuing a financial report to regulatory agencies comprising the steps of
displaying a graphical icon on an image of a pro form a financial statement;
displaying a list of one or more tasks contributing to the closing of each financial account;
displaying a graphical element illustrating the subjective confidence in the quality of each financial account;
displaying a selectable numerical element on an image of a pro form a financial display;
displaying the source document supporting a numerical element;
displaying the calculation supporting a numerical element;
displaying the assigned responsibilities for performing each task; and
digitally signing the financial report to archive the data, extracting a file for submission according to the specification of the regulatory agency, and publishing the report to authorized readers.

9. The program product of claim 8 embodied in computer-readible medium adapted to cause a processor to perform the method of displaying the intermediate results and progress of performing a financial close of an accounting period further comprising the steps of
accessing a computer readable file representing a financial report submitted to a regulatory agency;
copying all the graphic, images, and field names previously used into a new document;
inserting a graphical image for each field linked to a description of one or more close tasks contributing to the financial close of the field;
inserting a graphical image tag for each field linked to a color table which illustrates the subjective confidence or quality of values provided for each field;
linking each field to a display of the calculation or source of the values in each field; and
inserting an approval field for an authorized user to digitally sign and certify the correctness of the financial report.

10. The program product of claim 8, tangibly implemented in a computer system, for closing a financial accounting period, further comprising the steps of
establishing a work calendar, nomenclature, and number of work days in a window relative to the close date of a financial period appropriate to the business and financial policies of the enterprise;
defining the electronic contents of a close binder which would be the work product and record of all tasks, activities, and decisions deemed necessary to record, document, and illustrate the best practices associated with performing a financial close appropriate to the business and financial policies of the enterprise;
identifying organizations, departments, or functions that would be responsible for executing, completing, verifying, or escalating issues necessary for the timely completion of the electronic contents of a close binder for any period;
assigning individuals and recording their contact information for each of the roles defined necessary to perform, audit, or escalate the issues surrounding the creation of a close binder;
synchronizing the close date to a plurality of calendar dates according to the computer system wherein the begin and due date of tasks relative to a close date can be computed to determine the begin and due dates of activities by the calendar;
coordinating the activities of the individuals assigned to perform the tasks associated with creating a close binder, further comprising notifying, monitoring, tracking, and escalating the individual and his progress or timely completion of tasks;
recording the results of the close task activities, further comprising the attachment of supporting electronic documents, the notes made supporting decisions, the data from external sources entered into the system, the reconciliations of various inputs, and official signatures of attestation;
upon attestation that all tasks have been completed, all exceptions have been annotated, all issues have been addressed, and all results are correct, formally closing the financial period and locking down the close binder from further modification;
and distributing the selected contents of the close binder to authorized consumers of the information such as the securities and exchange commission, financial accounting services, and members of the board of directors.

11. The program product of claim 8 tangibly implemented on a computer system of scheduling and monitoring tasks of a financial close further comprising the following steps of
comparing the plurality of close dates of financial periods to the system clock to obtain the offset;
comparing the list of completed tasks to the list of tasks that should be activated according to the offset date from any close date;
notifying the individuals, organizations, departments, or function of their desired activity relative to tasks scheduled for the timely completion of a financial close;
displaying the status of activities in the list of all activities necessary for the timely completion of the financial close to the plurality of managers responsible for its success; and
escalating the absence of completion or activity as a new issue to the attention of managers responsible for the timely completion of the financial close.

12. The program product of claim 8 tangibly implemented in a computer system further comprising linking tasks defined in a financial close system to elements of a Sarbannes-Oxley system of financial controls so that notes related to compliance or non-compliance to financial controls can automatically transfer to the financial close system thereby documenting non-compliance yet still enabling the forcing of a financial period close.

13. The program product of claim 8 tangibly implemented in a computer system of further comprising the following steps: assigning tasks relative to a close date, computing the offset to the close date compared to the system calendar, electronically notifying individuals of the begin and end date of their tasks, recording activity, inactivity, or completion of tasks for display to managers responsible for timely completion of the close, archiving and producing an output package that is self contained in documenting the procedures, calculations, initiating and resolving of issues, assignment of responsibility, assumptions, exceptions, notes, reports, adjustments, and attestation of the results for syndication.

14. A program product of claim 8 for combining a close system of record and unifying financial reporting, close tasks, and internal controls, further comprising the method adapted to control the operation of a process to perform the steps following:
executing a Sarbanes-Oxley compliance system, said compliance system comprising internal control definition, internal control testing, and internal control analysis and attestation,
executing a financial close reporting system, said reporting system comprising, close automation processes, a close console, a task manager, and online close binders, and
displaying a financial close readiness system, said readiness system comprising a financial statement readiness console, readiness analytics, readiness automation, and readiness online binders.

15. A method, comprising the following steps
displaying a list of financial statement accounts, a plurality of quantitative values for each financial statement account, and one or more qualitative visual representation of the progress of achieving one or more close tasks or attesting to one or more financial controls.

16. A system comprising a processor, input systems, display systems, storage for data and instructions, and computer readable media adapted to control the processor to perform the steps of displaying a financial statement readiness console, displaying for each account quantitative financial data, displaying for each account qualitative data comprising at least one of the following: financial control qualitative data and financial close task qualitative data in the form of icons, colors, words, symbols, text, or graphics, wherein the qualitative data is selectable and invokes display of detailed supporting qualitative data.

17. The system of claim 16 further comprising a plurality of financial controls, a plurality of process services that perform the financial controls, collects qualitative metrics about the adequacy of performing the financial controls and maintains a continuous database for each financial account summarizing the qualitative confidence of each account in a financial statement.

18. The system of claim 16 further comprising a plurality of financial close tasks, a plurality of process services that perform the close tasks, collects qualitative metrics about the progress of completeness of performing the close tasks and maintains a continuous database for each financial account summarizing the qualitative readiness of each account in a financial statement.

19. A process for financial control and period reconciliation, comprising the methods of setting up a financial statement, assessing financial readiness, assembling a close binder, and producing financial statements.

20. The method for setting up a financial statement of claim 19 comprising the steps of defining the collection of a financial statement (disclosure) template using at least one of the following methods importing a template from a desktop file format or designing a template in place, identifying fields on financial statements to contain quantitative financial numbers and identifying fields on financial statements to contain static content, linking a financial statement line item to a financial account wherein the financial account is selected from the group comprising financial statement account, XPRL tag, and GL, and asserting completeness of the financial statement.

21. The method for assessing financial readiness of claim 19 comprising the steps of defining financial controls, defining financial close tasks, scheduling the steps of control and closing, recording the status of the processes of closing and controlling, and displaying financial control status and financial close task status on a financial statement.

22. The method of claim 21 for defining financial controls comprising the steps of specifying a name for a financial control, specifying a description of the financial control, specifying process steps for the financial control, specifying close binders the financial control is to be included in, specifying frequency, start, and end dates of the financial control, assigning process step participants of the financial control and linking the financial control to a financial account wherein the financial account is selected from the group financial statement account, XBRL tog, and general ledger.

23. A method of claim 21 for defining financial close tasks comprising the steps of specifying a name for a financial close task, specifying a description of the financial close task, specifying process steps of the financial close task, specifying close binders the financial close task is to be part of, specifying frequency, start and end dates of the financial close task, assigning process step participants of the financial close task, and linking the financial close task to a financial account wherein the financial account is selected from the group financial statement account, XBRL tag, and general ledger.

24. The method of assembling a close binder of claim 19 comprising the steps of defining close binders, closing a financial period, creating a map for a specific binder to all tagged items including at least one of the following control and close tasks, reference and collateral material files, creating an application independent recipe for all application views, creating the close binder, and archiving the close binder.

25. The method of assembling a close binder of claim 19, the method tangibly implemented in a computer readible medium adapted to control a computer system further comprising archiving and syndicating electronic files associated with a financial close comprising at least one of the following electronically signed documents of attestation, best practices and directed procedures, reports from external entities or erp systems, records of changes and modifications, memorandum of decisions, results of computations and the formulas supporting them, audits of physical or financial assets, and an electronic signature ensuring integrity of the archive or syndication.

26. The method for assembling a close binder of claim 19 further comprising
recording on a computer readable media of certain representations of the completion of steps pertaining to a financial period close process,
recording on said computer readable media of certain representations of the attestation of performance of financial controls pertaining to an element of a financial statement, determining the quantitative and textual content of each element of a financial statement, recording supporting records of values within financial statement accounts, and recording the formal certification and attestation that the values are accurate as of the date of recordation by authorized officers, whereby navigating a computer display of the financial statement elements through a control panel allows a reader to examine the supporting values, and record of completion of close process steps and of financial controls.

27. The method for assembling a close binder of claim 19 tangibly implemented on a computer system further comprising reopening and reclosing the books wherein a close binder placed under source code control may have proposed changes documented explained, approved or rejected and then, showing authorship and approvals, locked down and redistributed with changed results marked as corrections.

28. The method for producing financial statements of claim 19 comprising the steps of displaying qualitative status on an index of financial statements, closing financial statements, and outputting financial statements for reporting in at least one of the following formats: word, html, XBRL, and PDF.
